(19) United States
(12) Patent Application Publication
(10) Pub. No.: US 2024/0362526 A1
(43) Pub. Date: Oct. 31, 2024

(54) INFORMATION PROCESSING SYSTEM AND PROCESSING CONDITION DETERMINATION SYSTEM

(71) Applicant: Hitachi, Ltd., Tokyo (JP)

(72) Inventor: Hyakka NAKADA, Tokyo (JP)

(21) Appl. No.: 18/287,488

(22) PCT Filed: Apr. 8, 2022
(86) PCT No.: PCT/JP2022/017395

§ 371 Date: Oct. 19, 2023

(30) Foreign Application Priority Data
May 18, 2021 (JP) 2021-083895

(51) Int. Cl. G06N 20/00

(52) U.S. Cl. CPC G06N 20/00

(57) ABSTRACT

An information processing system enables searching for an optimum solution through annealing by converting, into an Ising model, a strong nonlinear objective function derived from machine learning. An objective function derivation system performs machine learning on a training database; and a function conversion system converts the objective function. The objective function derivation system includes: a machine learning setting unit; and a learning unit configured to derive the objective function. The function conversion system includes a dummy variable setting unit and generation unit, and a function conversion unit that reduces, by deleting the explanatory variable appearing explicitly in the objective function by using the dummy variable, a dimension of a nonlinear term of the explanatory variable at an order higher than quadratic to the quadratic or lower, and convert the objective function to the unconstrained quadratic-form function or the linear-constraint linear-form function related to the dummy variable and the objective variable.

### TECHNICAL FIELD

The present invention relates to an information processing system and a processing condition determination system.

### BACKGROUND ART

There is an annealing machine (or Ising machine) that searches for a global solution using an annealing method by converting an objective function into an Ising model as a valid analysis device that efficiently solves a combinatorial optimization problem. Here, the annealing method mainly includes simulated annealing and quantum annealing. In addition, it is known that the Ising model is a model in which a linear term and a quadratic term are considered in relation to a plurality of spin variables having a value of −1 or 1, and a part of an objective function of the combinatorial optimization problem such as a traveling salesman problem can be represented by the Ising model. However, in general, objective functions in many actual combinatorial optimization problems are not formulated in advance, and the Ising model is not defined. PTL 1 discloses a technique of related art for obtaining an optimum combination using an annealing machine in such a case.

PTL 1 discloses that an objective function is formulated from data, and a condition for minimizing or maximizing the objective function is optimized by using annealing such as quantum annealing.

### CITATION LIST

### Patent Literature

PTL 1: JP2019-96334A

### SUMMARY OF INVENTION

### Technical Problem

In order to optimize an objective function using the annealing machine as in the invention disclosed in PTL 1, it is necessary to convert the objective function into an Ising model. However, PTL 1 does not disclose a specific mapping method for converting an objective function into an Ising model.

An object of the invention is to provide an information processing system that enables search for an optimum solution through annealing or the like by converting, into an Ising model, a strong nonlinear objective function derived from machine learning.

### Solution to Problem

In order to solve the above problem, the present invention provides an information processing system that analyzes a training database including sample data related to one or more explanatory variables and one or more objective variables, and derives an unconstrained quadratic-form function or a linear-constraint linear-form function. The information processing system includes: an objective function derivation system configured to derive an objective function by performing machine learning on the training database; and a function conversion system configured to convert the objective function into the unconstrained quadratic-form function or the linear-constraint linear-form function. The objective function derivation system includes a machine learning setting unit configured to set details of a machine learning method, and a learning unit configured to derive the objective function using the machine learning method set by the machine learning setting unit. The function conversion system includes a dummy variable setting unit configured to set a generation method of a dummy variable that is a vector having only a value of 0 or 1 as a component, a dummy variable generation unit configured to generate the dummy variable based on the generation method set by the dummy variable setting unit, and a function conversion unit configured to reduce, by deleting the one or more explanatory variables appearing explicitly in the objective function by using the dummy variable, a dimension of a nonlinear term of the explanatory variable at an order higher than quadratic to the quadratic or lower, and convert the objective function to the unconstrained quadratic-form function or the linear-constraint linear-form function related to the dummy variable and the objective variable.

### Advantageous Effects of Invention

According to the invention, the strong nonlinear objective function at an order higher than the quadratic is converted into the unconstrained quadratic-form function or the linear-constraint linear-form function, and it is possible to search for the optimum solution using annealing, linear programming, integer programming, or the like.

Other problems and novel features will become apparent from the description of the present specification and the accompanying drawings.

### BRIEF DESCRIPTION OF DRAWINGS

FIG. 1 is a configuration example of an information processing system according to Embodiment 1.

FIG. 2A is a diagram showing a typical objective function derived using machine learning.

FIG. 2B is a diagram showing an unconstrained quadratic-form function obtained by generating a dummy variable for the objective function shown in FIG. 2A.

FIG. 3 is a flowchart performed by the information processing system according to Embodiment 1.

FIG. 4A is an example of a training database.

FIG. 4B is an example of a training database.

FIG. 5A is an example of true regression satisfied by an explanatory variable and an objective variable.

FIG. 5B is a diagram showing a state in which regression is estimated and a value of an explanatory variable providing a maximum value is searched for.

FIG. 5C is a diagram showing a state in which an acquisition function is estimated using Bayesian optimization and a value of an explanatory variable providing a maximum value is searched for.

FIG. 6A is a diagram showing a list of explanatory variables and generated dummy variables.

FIG. 6B shows an example of an output result of the unconstrained quadratic-form function related to the variables of FIG. 6A.

FIG. 6C shows an example of an output result (coefficient vector) of a linear-constraint linear-form function related to the variables of FIG. 6A.

FIG. 6D shows an example of an output result (constraint matrix, constraint constant vector) of the linear-constraint linear-form function related to the variables of FIG. 6A.

FIG. 7 is a configuration example of an information processing system according to Embodiment 2.

FIG. 8 is a flowchart performed by the information processing system according to Embodiment 2.

FIG. 9 is a configuration example of a processing condition determination system according to Embodiment 3.

FIG. 10 is a flowchart performed by the processing condition determination system according to Embodiment 3.

FIG. 11 is an example of an input GUI.

FIG. 12A is an example of an output GUI.

FIG. 12B is an example of an output GUI.

### DESCRIPTION OF EMBODIMENTS

Hereinafter, embodiments of the invention will be described with reference to the drawings. However, the invention should not be construed as being limited to the description of the embodiments described below. Those skilled in the art could have easily understood that specific configurations can be changed without departing from the spirit or scope of the invention.

Positions, sizes, shapes, ranges, and the like of the respective components shown in the drawings may not represent actual positions, sizes, shapes, ranges, and the like in order to facilitate understanding of the inventions. Therefore, the invention is not limited to the position, size, shape, and range disclosed in the drawings.

Since an Ising model is a model in which up to a quadratic term of a variable is taken into consideration, in order to convert a general combinatorial optimization problem into the Ising model, it is necessary to perform conversion of reducing a dimension by defining a term higher than the quadratic term as an additional spin variable. As a typical conversion method, a product X₁X₂ of two spin variables is set as a new spin variable Y₁₂, whereby a cubic term X₁X₂X₃ can be converted into a quadratic term Y₁₂X₃. However, since an objective function obtained using machine learning generally has a large number of high-order nonlinear terms, a large-scale additional spin variable is required when the objective function is converted into the Ising model by the above-described method. For example, a case where a highest order of the objective function is 10 is considered. In order to reduce a 10th order term to a quadratic term, eight additional spin variables are required. If there are 100 such terms, 800 additional variables are required. The additional spin variable is a vector having only a value of 0 or 1 as a component, and is hereinafter referred to as a dummy variable. In general, since the objective function obtained by the machine learning includes 9th order, 8th order, and 7th order terms, more variables are required. Since spin variables that can be handled by an annealing machine have an upper limit, it is difficult to perform optimization on such an objective function obtained by machine learning. Therefore, the present embodiment provides a technique of converting, into an Ising model, a strong nonlinear objective function derived from machine learning at high speed and with high accuracy, so that the number of dummy variables does not become enormous. Accordingly, it is possible to perform optimization using the annealing machine or the like by converting a complicated problem in the real world into an objective function by machine learning and further converting the objective function into the Ising model.

In the present embodiment, an objective function obtained using the machine learning, particularly a kernel method, is converted into the Ising model. It is known that the Ising model is equivalent to an unconstrained quadratic-form function (model of quadratic unconstrained binary optimization) related to a variable with which binary variables each having a value of 0 or 1 can be arranged by predetermined conversion. Therefore, a method of converting an objective function f(X) related to an explanatory variable X of the binary variable into the unconstrained quadratic-form function by appropriately generating a dummy variable will be described below. Here, the unconstrained quadratic-form function related to a variable vector x is a function of at most quadratic with respect to x, and is a function expressed by the following (Formula 1) using a symmetric matrix Q having the number of rows and the number of columns equal to the number of dimensions of x.

### [Math. 1]

X^{T}Qx (Formula 1)

Here, a superscript T indicates a transposition operation on a matrix. Hereinafter, the matrix Q is referred to as a coefficient matrix. For example, when a regression function obtained by using the kernel method is selected as an objective function, the objective function is represented by a linear sum of kernel functions according to the representer theorem. Since the objective function itself is generally a strong nonlinear function, the above-described method requires a large number of additional binary variables, that is, dummy variables in order to convert the objective function into the unconstrained quadratic-form function. However, the kernel function has less nonlinearity as compared with the objective function, and can be converted or approximated to the unconstrained quadratic-form function by a small number of dummy variables as described later. Accordingly, by converting the kernel function into the unconstrained quadratic-form function, the objective function that is a sum thereof can also be converted into the unconstrained quadratic-form function. When the annealing machine is used, a variable vector x=xₒₚₜ that provides a maximum value or a minimum value of the unconstrained quadratic-form function of (Formula 1) can be searched for, and thus, by removing a component of the dummy variable from xₒₚₜ, an explanatory variable x=xₒₚₜ that maximizes or minimizes the objective function can be obtained.

There are various kernel functions such as a radial basic function (RBF) kernel (Gaussian kernel), a polynomial kernel, and a Sigmoid kernel. Depending on a type of the kernel function, it is also possible to convert an objective function into a linear-constraint linear-form function.

Here, the linear-constraint linear-form function related to the variable vector x is a function represented by the following (Formula 2) using a vector a having a dimension equal to the number of dimensions of x, a matrix A having the number of columns equal to the number of dimensions of x, and a vector c having the number of dimensions equal to the number of rows of A.

$$\begin{matrix}[ Math . 2 ] & \\ {a}^{T} x s . t . Ax = c & ( Formula 2 )\end{matrix}$$

Hereinafter, the vector a is referred to as a coefficient vector, the matrix A is referred to as a constraint matrix, and the vector c is referred to as a constraint constant vector. In this case, it is possible to search for the variable vector x=xₒₚₜ that provides a maximum value or a minimum value of the linear-constraint linear-form function by using integer programming or linear programming instead of the annealing. As in the case of the unconstrained quadratic-form function, by removing the component of the dummy variable from xₒₚₜ, the explanatory variable x=xₒₚₜ that maximizes or minimizes the objective function can be obtained.

### Embodiment 1

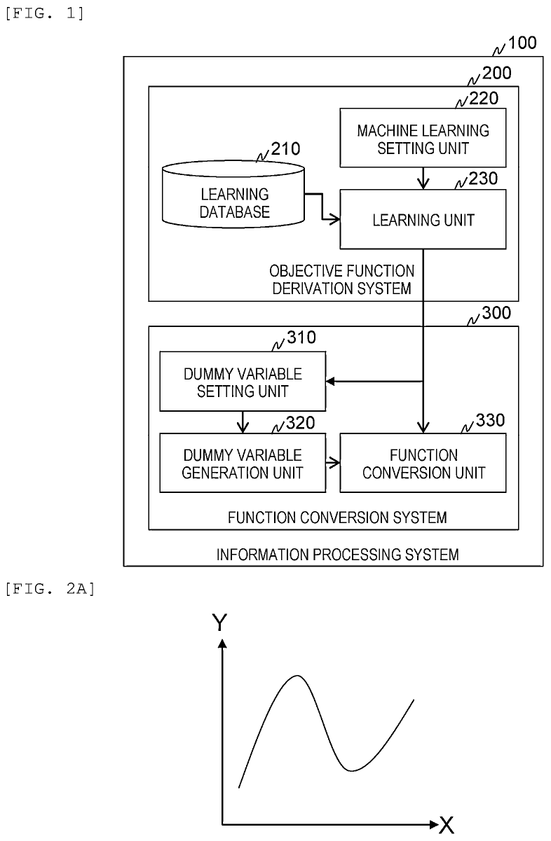

FIG. 1 is a diagram showing configuration example of an information processing system according to Embodiment 1. The information processing system according to Embodiment 1 derives an objective function from data of an explanatory variable and an objective variable using machine learning, converts the objective function into Ising mapping, specifically, an unconstrained quadratic-form function or a linear-constraint linear-form function, and outputs the converted objective function.

An information processing system 100 includes an objective function derivation system 200 that derives an objective function from sample data related to one or more explanatory variables X and one or more objective variables Y using machine learning, and a function conversion system 300 that generates a dummy variable X′ added to the explanatory variable X and converts the objective function into an unconstrained quadratic-form function related to X and X′ or a linear-constraint linear-form function.

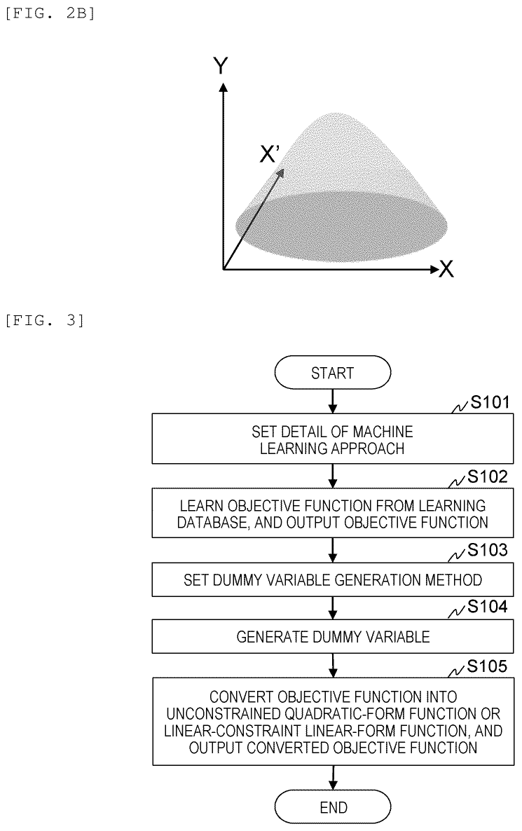

FIG. 2A shows an example of the objective function obtained by the objective function derivation system 200, and FIG. 2B shows an unconstrained quadratic-form function as an example of the Ising model obtained by the function conversion system 300.

The objective function derivation system 200 includes a training database 210 that stores the sample data of the explanatory variable X and the objective variable Y, a machine learning setting unit 220 that sets details of a machine learning method (such as a type and a specification) and a learning unit 230 that derives an objective function using the machine learning method set by the machine learning setting unit 220.

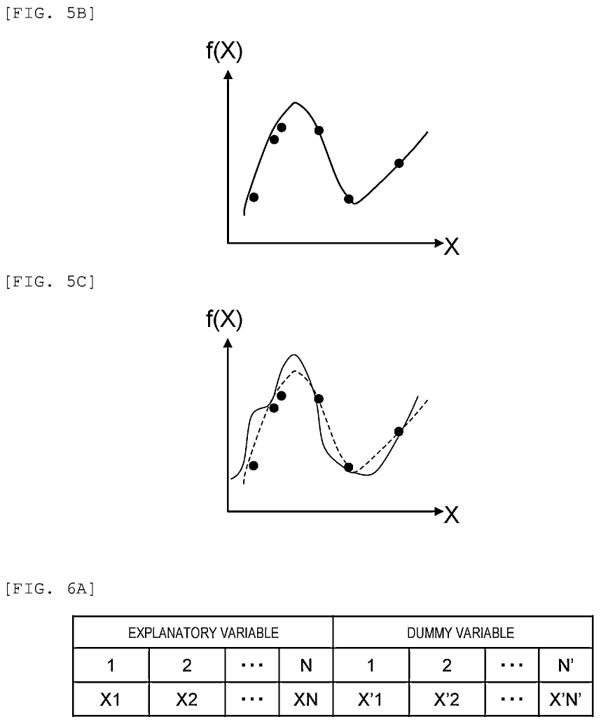

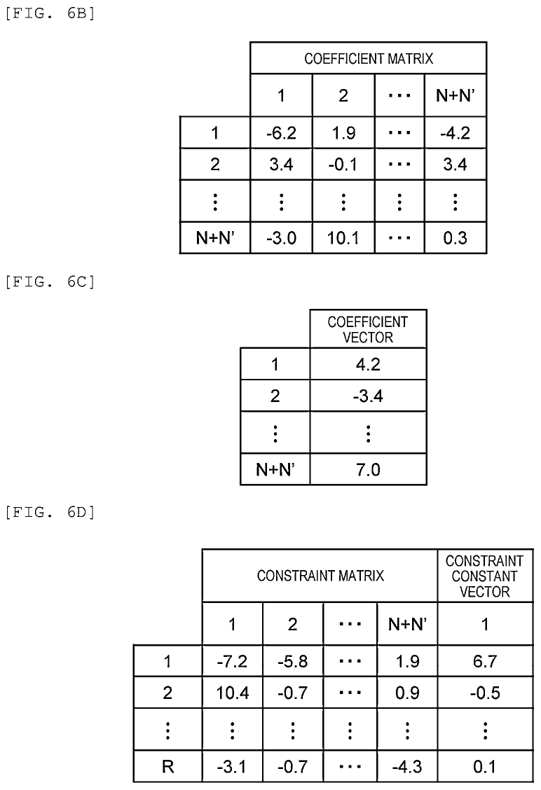

As shown in FIG. 4A, the training database 210 stores data on values of the explanatory variables and the objective variables for the number of samples as structured data. The number of objective variables may be two or more as shown in FIG. 4B. For example, a regression function Y=f(X) between the explanatory variable X=(X₁, X₂, . . . ) and the objective variable Y=(Y₁, Y₂, . . . ) serves as the objective function obtained by the learning unit 230. FIG. 5A shows an example of a true regression function, and FIG. 5B shows a regression function obtained by estimating the true regression from the sample data shown in FIG. 4. As the objective function, an acquisition function obtained by Bayesian optimization shown in FIG. 5C is also considered. The acquisition function is obtained by modifying the regression function estimated in FIG. 5B using prediction variance.

Further, particularly when there are two or more objective variables, that is, in a case of multi-objective optimization, a linear sum of regression functions for each objective variable can be selected as the objective function.

The function conversion system 300 includes a dummy variable setting unit 310 that sets a dummy variable generation method, a dummy variable generation unit 320 that generates a dummy variable based on the generation method set by the dummy variable setting unit 310, and a function conversion unit 330 that converts the objective function obtained by the learning unit 230 into an unconstrained quadratic-form function or a linear-constraint linear-form function and outputs the converted objective function. Here, when converting the objective variable, the function conversion unit 330 deletes one or more explanatory variables that explicitly appear in the objective function using the dummy variable, thereby performing a process of reducing a dimension of a nonlinear term of the explanatory variable at an order higher than the quadratic to the quadratic or lower.

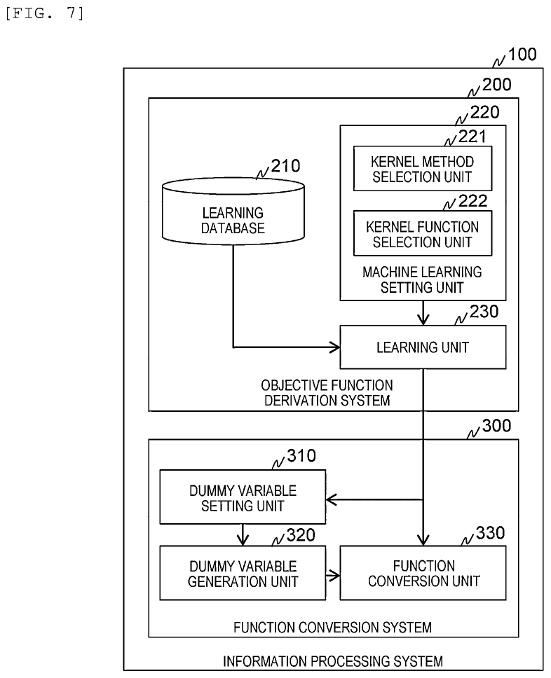

An example of the output result in the function conversion unit 330 is shown in FIGS. 6A to 6D. FIG. 6A shows a list of variables of the unconstrained quadratic-form function or the linear-constraint linear-form function, and the original explanatory variables and the dummy variables generated by the dummy variable generation unit 320 are displayed. When the objective function is converted into the unconstrained quadratic-form function, components of the coefficient matrix of (Formula 1) are output as shown in FIG. 6B. When the objective function is converted into the linear-constraint linear-form function, components of the coefficient vector, constraint matrix, and constraint constant vector of (Formula 2) are output as shown in FIGS. 6C and 6D.

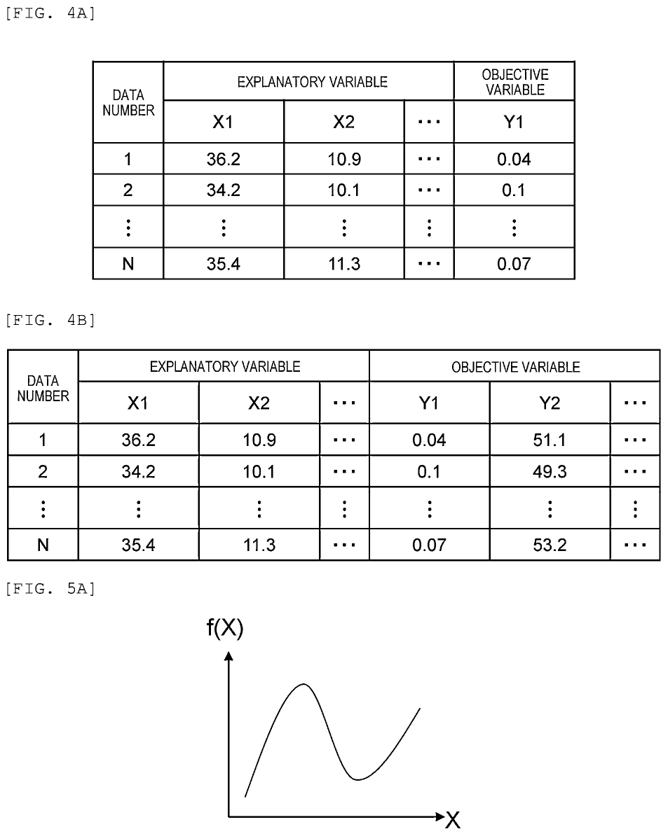

FIG. 3 is a flowchart for outputting the unconstrained quadratic-form function or the linear-constraint linear-form function by the information processing system 100 from a state where the sample data of the explanatory variable X and the objective variable Y is stored in the training database 210. Hereinafter, a method in which the information processing system 100 according to the present embodiment outputs the unconstrained quadratic-form function or the linear-constraint linear-form function will be described with reference to FIG. 3.

First, the machine learning setting unit 220 sets details of a machine learning method for deriving an objective function (step S101). For example, a learning type such as the kernel method, a neural network, or a decision tree is selected. In addition, in step S101, hyper parameters for learning, such as a type of kernel function or activation function, a depth of the tree, and a learning rate in error back-propagation, are also set.

Next, the learning unit 230 learns an objective function by machine learning under various conditions set by the machine learning setting unit 220 using data stored in the training database 210, and outputs the objective function to the function conversion unit 330 (step S102).

Next, a user determines the dummy variable generation method based on information of the objective function derived by the learning unit 230, and inputs the method to the dummy variable setting unit 310 (step S103). The generation method can be set by providing a constraint formula such that some functions related to the dummy variable X′ and the explanatory variable X are identically established as in the following (Formula 3).

$$\begin{matrix}[ Math . 3 ] & \\ h ( {X}^{′} , X ) = 0 & ( Formula 3 )\end{matrix}$$

Next, the dummy variable generation unit 320 generates a dummy variable by the dummy variable generation method set in step S103 (step S104). That is, the dummy variable generation unit 320 generates the dummy variable X′ such that (Formula 3) is established.

Specific examples of (Formula 3) will be described. For example, the user can set the method of generating a dummy variable by freely determining a natural number K being 2 or more among terms of the objective function derived by the learning unit 230, and defining, as a dummy variable, a single-term formula having a coefficient of 1 that divides a part where the coefficient is excluded for one or more of the single-term formulas of k=2, 3, 4, . . . , K of the explanatory variable. For example, when the objective function includes a term of −4X₁X₂X₃, a single-term formula X₂X₃ is defined as a dummy variable X′₁ since −4X₁X₂X₃ is dividable by X₂X₃. In this case, (Formula 3) is expressed as (Formula 4) below.

$$\begin{matrix}[ Math . 4 ] & \\ {X}_{1}^{′} - {X}_{2} {X}_{3} = 0 & ( Formula 4 )\end{matrix}$$

By setting K to be smaller than an order of the objective function, a scale of the number of dummy variables can be reduced, and even if the nonlinearity of the objective function obtained by machine learning is strong, the objective function can be converted into an Ising model. In addition, a dummy variable generation method described in step S204 according to Embodiment 2 to be described later may be set.

Finally, the function conversion unit 330 converts the objective function derived by the learning unit 230 into an unconstrained quadratic-form function or a linear-constraint linear-form function, and outputs the converted objective function (step S105). However, the unconstrained quadratic-form function or the linear-constraint linear-form function is a function related to the explanatory variable and the dummy variable. In addition, the function conversion unit 330 performs the above-described conversion by deleting one or more explanatory variables appearing in one or more terms of the objective function from the dummy variables generated by the dummy variable generation unit 320.

When the function conversion unit 330 outputs the linear-constraint linear-form function, the constraint formula of (Formula 3) is limited to the linear constraint formula, and the constraint of the linear-constraint linear-form function shown in (Formula 2) is provided by (Formula 3). When the unconstrained quadratic-form function is output by the function conversion unit 330, the converted objective function is output by adding a penalty term related to the constraint formula of (Formula 3). However, the penalty term is limited to the quadratic form.

### Embodiment 2

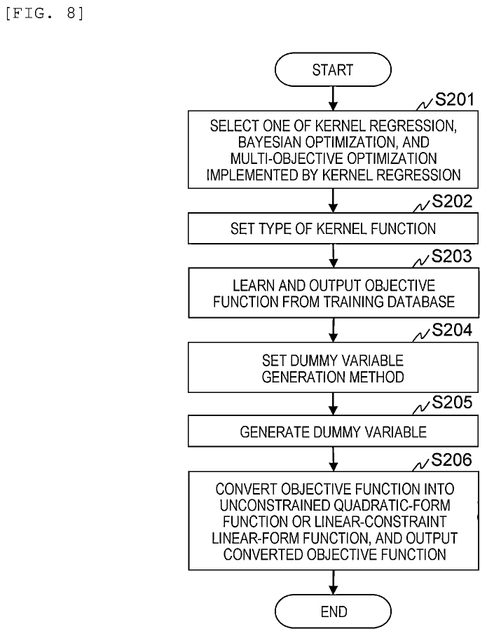

In Embodiment 2, the case where the kernel method is used as machine learning will be described. FIG. 7 is a diagram showing a configuration example of an information processing system according to Embodiment 2. The information processing system 100 according to Embodiment 2 derives an objective function from data of an explanatory variable and an objective variable using the kernel method, converts the objective function into an unconstrained quadratic-form function or a linear-constraint linear-form function, and outputs the converted objective function.

The definitions of the information processing system 100, the objective function derivation system 200, the training database 210, the machine learning setting unit 220, the learning unit 230, the function conversion system 300, the dummy variable setting unit 310, the dummy variable generation unit 320, and the function conversion unit 330 are the same as those of Embodiment 1.

In the machine learning setting unit 220 according to the present embodiment, details of the kernel method are particularly set. The machine learning setting unit 220 of the present embodiment includes a kernel method selection unit 221 and a kernel function selection unit 222. The kernel method selection unit 221 selects a kernel method to be used for deriving an objective function. In addition, the type of kernel function to be used in the kernel method is selected by the kernel function selection unit 222.

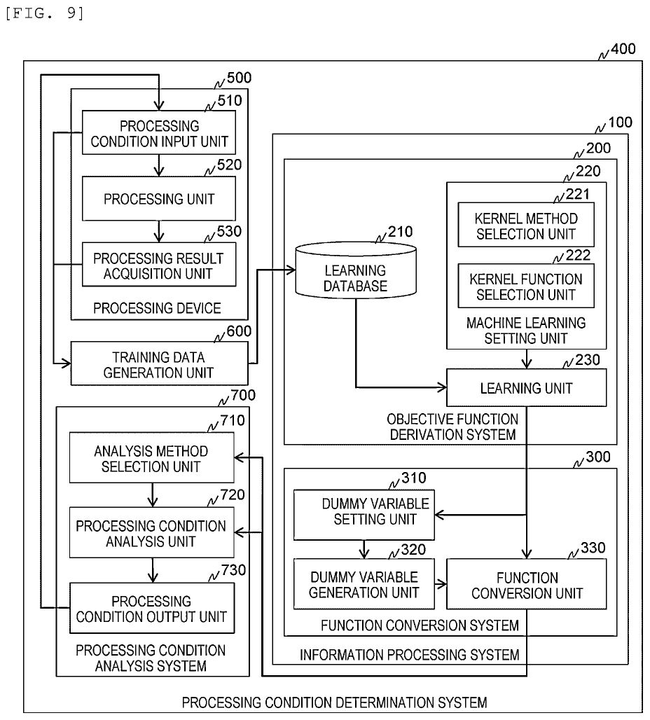

FIG. 8 is a flowchart for outputting the unconstrained quadratic-form function or the linear-constraint linear-form function by the information processing system 100 from a state where the sample data of the explanatory variable X and the objective variable Y is stored in the training database 210. Hereinafter, a method of outputting the unconstrained quadratic-form function or the linear-constraint linear-form function will be described with reference to FIG. 8.

First, the user selects one method of the kernel regression, the Bayesian optimization, and the multi-objective optimization implemented by the kernel regression in the kernel method selection unit 221 (step S201). For example, in a case where next search data is efficiently determined when there are less data and sparse learning regions, a method of the Bayesian optimization is selected. In addition, for example, when it is desired to obtain an optimum solution when there are a plurality of objective variables and the plurality of objective variables are in a tread-off relationship with one another, the method of the multi-objective optimization implemented by the kernel regression is selected.

Next, the user selects the type of kernel function in the kernel method selected in step S201 in the kernel function selection unit 222 (step S202). As the type of kernel function, functions such as a radial base function (RBF) kernel, a polynomial kernel, and a Sigmoid kernel are considered.

Next, the learning unit 230 learns and derives an objective function using the kernel method selected by the kernel method selection unit 221 and the kernel function selected by the kernel function selection unit 222 (step S203). Here, the derived objective function is the regression function in the case where the kernel regression is selected, the acquisition function in the case where the Bayesian optimization is selected, and the linear sum of regression functions for each objective variable in the case of multi-objective optimization implemented by the kernel regression. For example, when the kernel regression is selected by the kernel method selection unit 221, the kernel function selected by the kernel function selection unit 222 is approximated by addition of one or more basic functions to obtain a new kernel function, and the learning unit 230 derives an objective function by the kernel regression using the new kernel function.

Next, a user determines the dummy variable generation method based on information of the objective function derived by the learning unit 230, and inputs the method to the dummy variable setting unit 310 (step S204). In the present embodiment, the following two generation methods are particularly exemplified.

A first generation method is a method of generating a dummy variable by performing one-hot encoding on possible values of the kernel function. Here, the one-hot encoding performed on a variable x having M levels of values {λ₁, λ₂, . . . , λ_{M}} is a method of generating the dummy variables having the number of levels x′₁, x′₂, . . . , x′_{M}, so as to satisfy the following (Formula 5) and (Formula 6).

$$\begin{matrix}[ Math . 5 ] & \\ x = {\sum }_{k = 1}^{M} {λ}_{k} {x}_{k}^{′} & ( Formula 5 )\end{matrix}$$

$$\begin{matrix}[ Math . 6 ] & \\ {\sum }_{k = 1}^{M} {x}_{k}^{′} = 1 & ( Formula 6 )\end{matrix}$$

In the generation method, a vector of a binary variable is assumed as an explanatory variable. Since the number of possible values of the kernel function obtained by substituting the explanatory variable, that is, the level is proportional to a dimension of the explanatory variable, it is possible to prevent the number of dummy variables from becoming enormous. Accordingly, even if the nonlinearity of the objective function obtained by machine learning is strong, the objective function can be converted into an Ising model, and the optimization of the objective function can be implemented using an annealing machine or the like. (Formula 5) and (Formula 6) can be easily transformed into the form of (Formula 3). According to (Formula 5) and (Formula 6), the kernel function can be represented by a linear-constraint linear-form function related to the explanatory variable and the dummy variable.

A second generation method is a method in which a kernel function is approximated by implementing fitting through addition of one or more basic functions, and a conjugation variable in dual conversion of the basic functions is defined as a dummy variable. As a duality problem, any of a Lagrange duality problem, a Fenchel duality problem, a Wolfe duality problem, and a Legendre duality problem is considered. Although the vector of the binary variable is assumed as the explanatory variable in the first generation method, the second generation method is not limited to the assumption. The basic function used here is represented in a quadratic form in relation to the conjugation variable and the explanatory variable of the duality problem. As such a basic function, there are a large number of functions such as a rectified linear unit (ReLU) function, a numerical operation function for returning an absolute value, or an instruction function that receives a linear form or a quadratic form of an explanatory variable as an input. By using such a basic function, it is possible to approximate the kernel function by a quadratic-form function related to the explanatory variable and the dummy variable by using the conjugation variable of the above-described duality problem as the dummy variable. In addition, a constraint condition of the conjugation variable required by the duality problem may be the constraint formula of (Formula 3) satisfied by the dummy variable. Accordingly, after the kernel function is approximated by the quadratic-form function related to the explanatory variable and the dummy variable, by adding a quadratic-form penalty term related to the constraint formula of (Formula 3), the kernel function can be represented by the unconstrained quadratic-form function.

Also in the second generation example, if a basic function in which the number of conjugation variables has a small scale is used, it is possible to prevent the number of dummy variables from becoming enormous, and it is also possible to convert a strong nonlinear objective function into an Ising model. When the kernel function is fitted (approximated) by the addition of one or more basic functions, a least-squares method or a minimum absolute value method related to an approximation error between the kernel function and the addition of the basic functions is used, and thus it is possible to perform the fitting with high accuracy.

Subsequent steps S205 and S206 have the same definitions as steps S104 and S105 in Embodiment 1, respectively. When the kernel regression or the multi-objective optimization implemented by the kernel regression is selected by the kernel method selection unit 221 in step S201, the function conversion unit 330 converts the objective function into a linear-form function related to a dummy variable, and imposes a constraint related to the dummy variable generated by the dummy variable generation unit 320, thereby deriving a constraint linear-form function. At this time, the function conversion unit 330 can also derive an unconstrained quadratic-form function by adding a quadratic-form penalty term for the constraint to the converted linear-form function. When the Bayesian optimization is selected by the kernel method selection unit 221 in step S201, the function conversion unit 330 converts the objective function into a quadratic-form function related to a dummy variable, and derives an unconstrained quadratic-form function.

### Embodiment 3

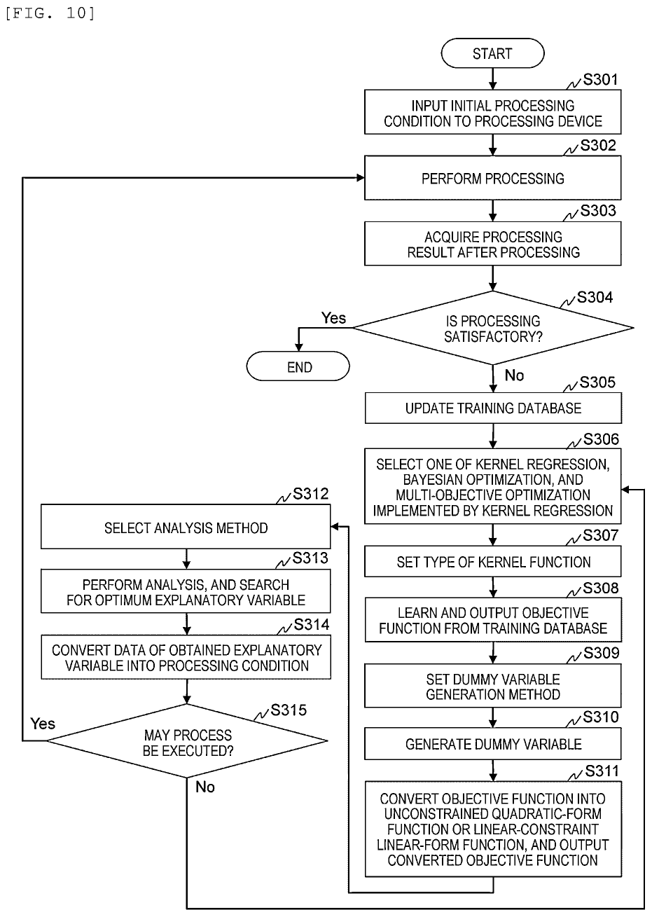

In Embodiment 3, a processing condition determination system that determines a processing condition of a processing device using the information processing system according to Embodiment 2 will be described. FIG. 9 is a diagram showing a configuration example of the processing condition determination system according to Embodiment 3.

The definitions of the information processing system 100, the objective function derivation system 200, the training database 210, the machine learning setting unit 220, the kernel method selection unit 221, the kernel function selection unit 222, the learning unit 230, the function conversion system 300, the dummy variable setting unit 310, the dummy variable generation unit 320, and the function conversion unit 330 are the same as those of Embodiment 2.

A processing condition determination system 400 includes the objective function derivation system 200, the function conversion system 300, a processing device 500, a training data generation unit 600, and a processing condition analysis system 700, and determines processing conditions of the processing device 500.

The processing device 500 is a device that performs some processes on a target sample. The processing device 500 includes a semiconductor processing device. Examples of the semiconductor processing device include a lithography device, a film forming device, a pattern processing device, an ion implantation device, a heating device, and a cleaning device.

Examples of the lithography device include an exposure device, an electron beam lithography device, and an X-ray lithography device.

Examples of the film forming device include a chemical vapor deposition (CVD) device, a physical vapor deposition (PVD) device, a vapor deposition device, a sputtering device, and a thermal oxidation device. Examples of the pattern processing device includes a wet etching device, a dry etching device, an electron beam processing device, and a laser processing device. Examples of ion implantation device include a plasma doping device and an ion beam doping device. Examples of the heating device include a resistance heating device, a lamp heating device, and a laser heating device. The processing device 500 may be an additive manufacturing device. The additive manufacturing device includes additive manufacturing devices of various types such as liquid tank photopolymerization, material extrusion, powder bed fusion bonding, binder injection, sheet lamination, material injection, and directional energy deposition. The processing device 500 is not limited to the semiconductor processing device or the additive manufacturing device.

The processing device 500 includes a processing condition input unit 510 that inputs the processing condition output from a processing condition analysis system 700, and a processing unit 520 that performs the processes of the processing device 500 using the processing condition input by the processing condition input unit 510. In FIG. 9, a processing result acquisition unit 530 that acquires a processing result of the processing unit 520 is mounted in the processing device 500, but may be in a stand-alone mode with respect to the processing device 500. In the processing unit 520, a sample is placed therein, and the processes are performed on the sample.

The training data generation unit 600 processes (converts) the processing condition input to the processing condition input unit 510 into data of the explanatory variable and the processing result acquired by the processing result acquisition unit 530 into data of the objective variable, and then stores the processed data in the training database 210.

The processing condition analysis system 700 includes an analysis method selection unit 710 that selects an analysis method of a value of the explanatory variable according to the type of the function derived by the function conversion system 300, a processing condition analysis unit 720 that calculates the value of the explanatory variable providing the minimum value or the maximum value of the input function using the analysis method selected by the analysis method selection unit, and a processing condition output unit 730 that processes (converts) the value of the explanatory variable obtained by the processing condition analysis unit 720 into the processing condition and outputs the processing condition to the processing device 500.

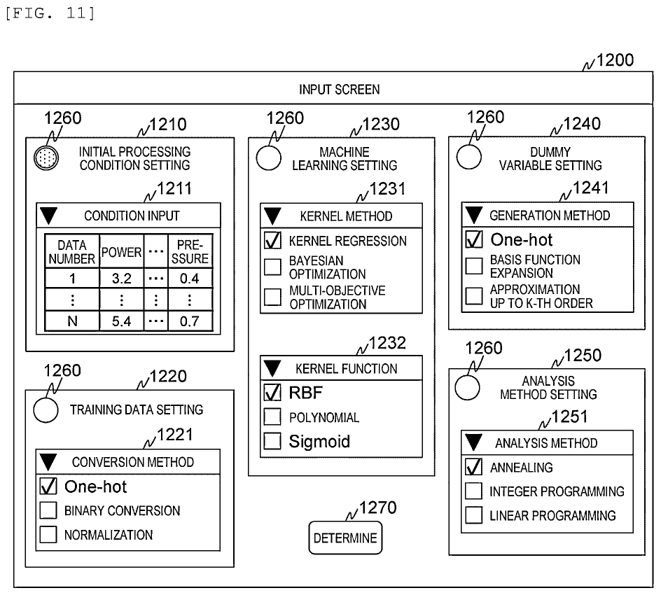

FIG. 10 is a flowchart for determining the processing condition of the processing device 500. Hereinafter, a method in which the processing condition determination system 400 determines the processing condition of the processing device 500 will be described with reference to FIG. 10.

First, the user inputs any processing condition through the processing condition input unit 510 (step S301). Here, the input processing condition is referred to as an initial processing condition, and may be plural. As the initial processing condition, a processing condition having a processing record in the past in the processing device 500 or a related device may be selected, or a processing condition using an experimental programming method may be selected. Next, the processing unit 520 performs processing on the sample using the condition input to the processing condition input unit 510 (step S302). However, when the processed sample remains in the processing unit 520, the processed sample is removed, and the processing is performed after a new sample before being processed is provided in the processing unit 520. When there are a plurality of processing conditions, the processing is performed every time the sample is replaced. After the processing, the processing result acquisition unit 530 acquires a processing result (step S303). When the processing result satisfies the user, the process ends, and when the processing result is not satisfactory, the process proceeds to step S305 (step S304).

Next, after the training data generation unit 600 converts the processing condition input to the processing condition input unit 510 into the data of the explanatory variable and the processing result acquired by the processing result acquisition unit 530 into the data of the objective variable, the training data generation unit 600 stores the processed data in the training database 210, and updates the training database (step S305). Here, the training data generation unit 600 can convert the processing condition data into the data of the explanatory variable represented by binary variables by performing binary conversion or one-hot encoding. In addition, the training data generation unit 600 may perform normalization or the like, or may perform a combination of two or more conversion methods.

Among the subsequent steps, steps S306, S307, S308, S309, S310, and S311 are the same as steps S201, S202, S203, S204, S205, and S206 of Embodiment 2, respectively.

In S311, the function conversion unit 330 of the function conversion system 300 converts the objective function for the explanatory variable and the objective variable into an unconstrained quadratic-form function or a linear-constraint linear-form function and outputs the converted objective function, and then the analysis method selection unit 710 selects an analysis method of the function (step S312). That is, when the function output in S311 is an unconstrained quadratic-form function, the annealing is selected. When the function output in S311 is a linear-constraint linear-form function, the integer programming or the linear programming is selected. As described above, in the processing condition determination system 400 according to the present embodiment, by selecting an appropriate analysis method according to the objective function, not only the unconstrained quadratic-form function but also the linear-constraint linear-form function can be coped with and can be used properly by the user.

Next, the processing condition analysis unit 720 performs analysis on the function output in S311 using the analysis method selected by the analysis method selection unit 710 (step S313). By the analysis in step S313, it is possible to search for the value xₒₚₜ of the variable x at which this function becomes maximum or minimum. Here, since this variable is a variable constituted by an explanatory variable and a dummy variable as shown in FIG. 6A, an optimum explanatory variable X=Xₒₚₜ can be obtained by removing the component of the dummy variable from xₒₚₜ. In step S313, such Xₒₚₜ is searched for and output.

The processing condition output unit 730 converts the data of the value of the explanatory variable obtained in step S313 into the processing condition (step S314). A plurality of processing conditions may be obtained. Next, the user determines whether the process of the processing device 500 may be executed based on the processing condition obtained in step S314, and when the process may be executed, the processing condition output unit 730 inputs the processing condition to the processing condition input unit 510. When the process is not executed, the processing returns to step S305 and the subsequent steps, and the kernel method, the kernel function, the dummy variable generation method, and the analysis method are reset. By repeating a series of steps from step S302 to step S315 until a processing result satisfying the user is obtained in step S304, it is possible to determine a high-quality processing condition.

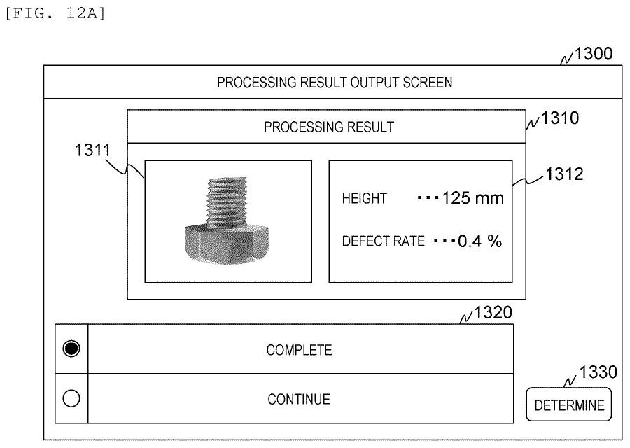

A GUI according to Embodiment 3 will be described with reference to FIGS. 11 and 13. FIG. 11 is an input GUI 1200, which is an example of an input screen for inputting settings of the processing condition determination system 400 according to Embodiment 3. This input screen is presented at the time of the procedure of step S301.

The input GUI 1200 includes an initial processing condition setting box 1210, a training data setting box 1220, a machine learning setting box 1230, a dummy variable setting box 1240, an analysis method setting box 1250, a valid/invalid display unit 1260, and a determination button 1270.

The initial processing condition setting box 1210 includes a condition input unit 1211. By the condition input unit 1211, for example, a data number, each factor name of a processing condition, and a value of each factor of each piece of data can be input to a structure such as a csv file as an initial processing condition. These factors are control factors of the processing device 500, and power and pressure are served as factors in the example of FIG. 11. By the input as described above, the initial processing condition can be input to the processing condition input unit 510 of the processing device 500.

The training data setting box 1220 includes a conversion method input unit 1221. In the conversion method input unit 1221, for example, a method of converting a processing condition into the data of the explanatory variable using any one or more of one-hot encoding, binary conversion, and normalization is selected. Although only one method is selected in FIG. 11, a plurality of methods may be selected. The training data generation in the training data generation unit 600 is performed using the input method.

The machine learning setting box 1230 includes a kernel method input unit 1231 and a kernel function input unit 1232. In the kernel method input unit 1231, for example, one of the kernel regression, the Bayesian optimization, and the multi-objective optimization implemented by the kernel regression is selected. By the above input, selection of the kernel method in the kernel method selection unit 221 is performed. In FIG. 11, the multi-objective optimization implemented by the kernel regression is simply abbreviated as the multi-objective optimization.

In the kernel function input unit 1232, an RBF kernel, a polynomial kernel, a Sigmoid kernel, or the like is selected. By this input here, selection of the kernel function in the kernel function selection unit 222 is performed.

The dummy variable setting box 1240 includes a generation method input unit 1241. In the example shown in FIG. 11, the generation method input unit 1241 can select the generation method from, for example, three (each abbreviated as one-hot, basic function expansion, and approximation up to the K-th order) as the dummy variable generation method. The one-hot is a first generation method described in Embodiment 2, and is a method according to one-hot encoding for a kernel function. The basic function expansion is a second generation method described in Embodiment 2, and is a method in which a kernel function is approximated by addition of basic functions, and a conjugation variable in a duality problem of the basic functions is defined as a dummy variable. The approximation up to the K-th order is the generation method described in Embodiment 1, and is a method in which a natural number K 2 is appropriately determined, and a single-term formula having a coefficient of 1 that divides a part where the coefficient is excluded is defined as a dummy variable for one or more of the single-term formulas of k=2, 3, 4, . . . , K of the explanatory variable. In this manner, the setting of the dummy variable generation method in the dummy variable setting unit 310 is performed.

The analysis method setting box 1250 includes an analysis method input unit 1251. The annealing, integer programming, linear programming, or the like is selected as the analysis method. By this input here, the analysis method setting in the analysis method selection unit 710 is performed.

Whether the above input is performed validly is displayed on the valid/invalid display unit 1260 provided in each of the setting boxes. When all of the valid/invalid display units 1260 become valid, the user presses the determination button 1270 on the input GUI 1200, thereby starting the procedure of step S302 in Embodiment 3.

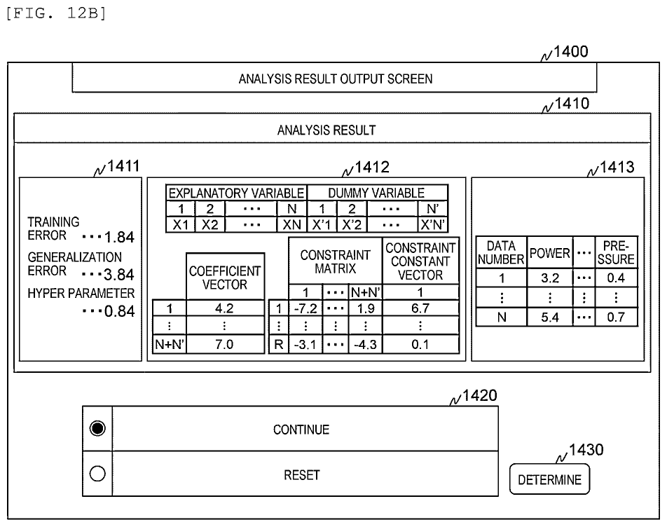

The determination button 1270 of the input GUI 1200 is pressed, the procedure of FIG. 10 is executed, and a processing result output GUI 1300 is shown in FIG. 12A as an output GUI presented after step S303. The GUI displays a current status and allows the user to select whether to proceed to the next procedure.

The processing result output GUI 1300 includes a processing result display unit 1310, a completion/continuation selection unit 1320, and a determination button 1330.

The processing result display unit 1310 includes a sample display unit 1311 and a processing result display unit 1312. The sample display unit 1311 shows a state of the sample after the processing in step S302 is completed.

The processing result display unit 1312 displays the processing result acquired in step S303. FIG. 12A shows the processing result output GUI 1300 when the additive manufacturing device is assumed as the processing device 500 and a screw shaped object is assumed as a target sample. The sample display unit 1311 shows an appearance of the screw shaped object after a shaping process, and the processing result display unit 1312 shows a height and a defect rate of the shaped object as the processing result of the screw shaped object after the shaping process.

The user can select whether to complete or continue in the completion/continuation selection unit 1320 based on the information displayed on the processing result display unit 1310. That is, the user can perform the operation of step S304 on the GUI. When the user is satisfied with the processing result, the user selects the completion and presses the determination button 1330, thereby ending the step as shown in FIG. 10. When the user determines that the processing result is not satisfactory, the user selects the continuation and presses the determination button 1330, and the process proceeds to step S305.

The determination button 1330 of the processing result output GUI 1300 is pressed, the procedure of FIG. 10 is executed, and an analysis result output GUI 1400 is shown in FIG. 12B as an output GUI presented after step S314. The GUI displays a current status and allows the user to select whether to proceed to the next procedure. The analysis result output GUI 1400 includes an analysis result display unit 1410, a continuation/reset selection unit 1420, and a determination button 1430.

The analysis result display unit 1410 includes an objective function display unit 1411, a function conversion result display unit 1412, and a processing condition analysis result display unit 1413. The objective function display unit 1411 displays information on the objective function derived in step S308. The function conversion result display unit 1412 displays information on the unconstrained quadratic-form function or the linear-constraint linear-form function derived in step S311. The processing condition analysis result display unit 1413 displays the processing condition obtained in step S314.

A specific example of the display content described above will be described with reference to FIG. 12B. For example, in the objective function display unit 1411, a value of a hyper parameter, a training error, and a generalization error when the objective function is derived in the learning unit 230 are displayed. For example, the function conversion result display unit 1412 displays the information shown in FIG. 7 output from the function conversion unit 330. That is, terms of explanatory variables and dummy variables, coefficient vector, constraint matrices, and constraint constant vectors of the linear-constraint linear-form function, or coefficient matrices of the unconstrained quadratic-form function, and the like are displayed. For example, the processing condition analysis result display unit 1413 displays the processing condition output from the processing condition output unit 730.

The user can select whether to continue or reset in the continuation/reset selection unit 1420 based on the information displayed in the analysis result display unit 1410. That is, the user can perform the operation of step S315 on the GUI. When the user determines that the process of the processing device 500 may be performed using the processing condition displayed in the processing condition analysis result display unit 1413, the continuation is selected, and the determination button 1430 is pressed, so that the processing condition is input to the processing condition input unit 510, and the process proceeds to step S302. When the user determines that the process of the processing device 500 is not to be performed, the reset is selected, and the determination button 1430 is pressed, so that the process proceeds to step S306. The above determination is made based on any one of the numerical value of each factor in the processing condition displayed on the processing condition analysis result display unit 1413, the derivation result of the objective function displayed on the objective function display unit 1411, and the function conversion result displayed on the function conversion result display unit 1412. For example, when it is determined that the numerical value of the specific factor of the processing condition displayed on the processing condition analysis result display unit 1413 is not preferable for the operation of the processing device 500, the reset may be selected. In addition, when it is expected that the objective function causes over-learning based on the information on the objective function displayed on the objective function display unit 1411, the reset may be selected. Further, when the number of dummy variables of the function displayed on the function conversion result display unit 1412 exceeds a reference value of the user, the reset may be selected.

### REFERENCE SIGNS LIST

100: information processing system
210: training database
220: machine learning setting unit
221: kernel method selection unit
222: kernel function selection unit
230: learning unit
300: function conversion system
310: dummy variable setting unit
320: dummy variable generation unit
330: function conversion unit
400: processing condition determination system
500: processing device
510: processing condition input unit
520: processing unit
530: processing result acquisition unit
600: training data generation unit
700: processing condition analysis system
710: analysis method selection unit
720: processing condition analysis unit
730: processing condition output unit
1200: input GUI
1210: initial processing condition setting box
1211: condition input unit
1220: training data setting box
1221: conversion method input unit
1230: machine learning setting box
1231: kernel method input unit
1232: kernel function input unit
1240: dummy variable setting box
1241: generation method input unit
1250: analysis method setting box
1251: analysis method input unit
1260: valid/invalid display unit
1270: determination button
1300: processing result output GUI
1310: processing result display unit
1311: sample display unit
1312: processing result display unit
1320: completion/continuation selection unit
1330: determination button
1400: analysis result output GUI
1410: analysis result display unit 1411: objective function display unit
1412: function conversion result display unit
1413: processing condition analysis result display unit
1420: continuation/reset selection unit
1430: determination button

1. An information processing system that analyzes a training database including sample data related to one or more explanatory variables and one or more objective variables, and derives an unconstrained quadratic-form function or a linear-constraint linear-form function, the information processing system comprising:
an objective function derivation system configured to derive an objective function by performing machine learning on the training database; and
a function conversion system configured to convert the objective function into the unconstrained quadratic-form function or the linear-constraint linear-form function, wherein
the objective function derivation system includes
a machine learning setting unit configured to set details of a machine learning method, and
a learning unit configured to derive the objective function using the machine learning method set by the machine learning setting unit, and
the function conversion system includes
a dummy variable setting unit configured to set a dummy variable generation method as a vector having only a value of 0 or 1 as a component,
a dummy variable generation unit configured to generate the dummy variable based on the generation method set by the dummy variable setting unit, and
a function conversion unit configured to reduce, by deleting the one or more explanatory variables appearing explicitly in the objective function by using the dummy variable, a dimension of a nonlinear term of the explanatory variable at an order higher than quadratic to the quadratic or lower, and convert the objective function to the unconstrained quadratic-form function or the linear-constraint linear-form function related to the dummy variable and the objective variable.

2. The information processing system according to claim 1, wherein
the machine learning method set by the machine learning setting unit is a kernel method.

3. The information processing system according to claim 2, wherein
the machine learning setting unit includes
a kernel method selection unit configured to allow one of kernel regression, Bayesian optimization, and multi-objective optimization implemented by kernel regression to be selected, and
a kernel function selection unit configured to allow a type of a kernel function to be selected,
when the kernel regression is selected by the kernel method selection unit, the objective function is a regression function of the kernel regression,
when the Bayesian optimization is selected by the kernel method selection unit, the objective function is an acquisition function by Bayesian optimization, and
when the multi-objective optimization implemented by the kernel regression is selected by the kernel method selection unit, the objective function is a function given by a linear sum of one or more regression functions of kernel regression.

4. The information processing system according to claim 3, wherein
the explanatory variable is a vector having only a value of 0 or 1 as a component.

5. The information processing system according to claim 4, comprising
as the generation method set by the dummy variable setting unit, a generation method of generating the dummy variable by performing one-hot encoding on possible values of the kernel function selected by the kernel function selection unit.

6. The information processing system according to claim 4, wherein
when the kernel regression or the multi-objective optimization implemented by kernel regression is selected by the kernel method selection unit, the function conversion unit converts the objective function into a linear-form function related to the dummy variable, and imposes a constraint related to the dummy variable generated by the dummy variable generation unit, thereby deriving the linear-constraint linear-form function.

7. The information processing system according to claim 4, wherein
when the Bayesian optimization is selected by the kernel method selection unit, the function conversion unit converts the objective function into a quadratic-form function related to the dummy variable, thereby deriving the unconstrained quadratic-form function.

8. The information processing system according to claim 4, wherein
when the kernel regression or the multi-objective optimization implemented by kernel regression is selected by the kernel method selection unit, the function conversion unit converts the objective function into a linear-form function related to the dummy variable, and adds a quadratic-form penalty term for a constraint related to the dummy variable generated by the dummy variable generation unit, thereby deriving the unconstrained quadratic-form function.

9. The information processing system according to claim 4, wherein
when the kernel regression is selected by the kernel method selection unit, the kernel function selected by the kernel function selection unit is approximated by addition of one or more basic functions to obtain a new kernel function, and the learning unit derives the objective function by the kernel regression using the new kernel function.

10. The information processing system according to claim 9, wherein
when the kernel function is approximated by addition of the basic functions, a least-squares method or a minimum absolute value method related to an error between the kernel function and the addition of the basic functions is used.

11. The information processing system according to claim 10, wherein
the dummy variable generation unit generates a conjugation variable in dual conversion for the basic functions as a part of the dummy variable.

12. The information processing system according to claim 11, wherein
the basic function is any one of a rectified linear unit (ReLU) function, a numerical operation function for returning an absolute value, and an instruction function that receives a linear form or a quadratic form of the explanatory variable as an input.

13. A processing condition determination system comprising:
the information processing system according to claim 3;
a processing device;
a processing condition analysis system configured to output a processing condition of the processing device; and
a training data generation unit configured to process and output data of the processing condition and data of an obtained processing result, wherein
the processing condition determination system determines the processing condition of the processing device,
the processing device includes
a processing condition input unit configured to input the processing condition output from the processing condition analysis system,
a processing unit configured to perform a process of the processing device using the processing condition input by the processing condition input unit, and
a processing result acquisition unit configured to acquire a processing result of the processing unit,
the processing condition analysis system includes
an analysis method selection unit configured to select an analysis method of a value of the explanatory variable according to a type of the function derived by the information processing system,
a processing condition analysis unit configured to calculate the value of the explanatory variable providing a minimum value or a maximum value of the input function using the analysis method selected by the analysis method selection unit, and
a processing condition output unit configured to process the value of the explanatory variable obtained by the processing condition analysis unit into the processing condition and output the processed value,
and inputs the processing condition input by the processing condition input unit and the processing result acquired by the processing result acquisition unit to the training data generation unit,
the training data generation unit processes the processing condition input by the processing condition input unit into data of the explanatory variable and the processing result output from the processing result acquisition unit into data of the objective variable, and stores the processed data in the training database,
the function derived by the information processing system is input to the analysis method selection unit,
the processing condition output by the processing condition output unit is input to the processing condition input unit, and
until a desired processing result is obtained, the function derivation performed by the information processing system, the output of the processing condition performed by the processing condition analysis system, the process performed by the processing device, and the storage of the data of the explanatory variable and the data of the objective variable in the training database performed by the training data generation unit are repeated.

14. The processing condition determination system according to claim 13, wherein
the analysis method selection unit selects annealing when the function derived by the information processing system is an unconstrained quadratic-form function, and selects integer programming or the linear programming when the function derived by the information processing system is a linear-constraint linear-form function.

15. The processing condition determination system according to claim 13, wherein
the training data generation unit generates data of the explanatory variable by performing binary conversion or one-hot encoding on the input data of the processing condition.
